(19) United States
(12) Patent Application Publication
(10) Pub. No.: US 2009/0260336 A1
(43) Pub. Date: Oct. 22, 2009

(54) Stirrup assembly

(76) Inventor: Robert Gottlieb, Houston, TX (US)

Correspondence Address: POLSINELLI SHUGHART PC, 700 West 47th Street, Suite 1000, KANSAS CITY, MO, 64112, US

(21) Appl. No.: 12/378,125

(22) Filed: Feb. 11, 2009

Related U.S. Application Data
(63) Continuation-in-part of application No. 11/796,060, filed on Apr. 26, 2007, now Pat. No. 7,574,849.

(51) Int. Cl. B68C 3/02; B68C 3/00

(52) U.S. Cl. 54/71; 54/47; 54/49

(57) ABSTRACT

A stirrup assembly for aiding a rider when mounting a horse provides a stirrup assembly wherein part or all of the side of a stirrup can be rotated down into a locked horizontal position to become a step. The act of pulling down the movable side part compresses a strong return spring. When the movable side part is fully down, a latch is set which keeps it from returning. What was part of the stirrup side can now be used as a step for mounting and is quickly returned to its original upright position by the return spring when the rider steps on the latch release.

### CROSS-REFERENCE TO RELATED APPLICATIONS

This application is a continuation-in-part of my co-pending application Ser. No. 11/796,060 filed in Apr. 26, 2007 entitled “Horse Mounting Aid Assembly,” the full disclosure of which is incorporated by reference herein, and priority of which is hereby claimed.

### BACKGROUND OF THE INVENTION

This invention relates to the field of horsemanship and equestrian equipment, and more particularly to a stirrup that can be transformed into a mounting aid. In one of its forms, the mounting aid will keep the rider safe during both mounting and riding.

The stirrups form part of conventional horse mounting equipment; they are positioned on both sides of the saddle and assist a rider in mounting a horse and in maintaining balance while riding. A stirrup is normally positioned so that the rider's feet rest on the stirrup bed when mounted comfortably on the horse. Depending on the height of the horse and/or the rider, it is many times very difficult to mount the horse when the stirrups are adjusted properly for riding. A mounting block or a ‘leg up’ may be required for the person to mount the horse. These aids are not always available.

The present invention contemplates elimination of prior art drawbacks and provision of a stirrup assembly that assists the rider in the mounting process and hinges for storage so as not to interfere during horse riding.

The present invention is unique in that it can be manufactured in either an English or Western style and will transform into a form that will assist a person when mounting a horse from the ground. In one of its forms it will be safer than a conventional stirrup whether mounting or riding.

### SUMMARY OF THE INVENTION

It is, therefore, an object of the present invention to provide a stirrup assembly wherein part or all of the side of a stirrup can be rotated down into a locked horizontal position to facilitate mounting a horse. The act of pulling down the movable side part compresses a strong return spring. When the movable side part is fully down, a latch is set which keeps it from returning until the rider steps on the latch release. The step is therefore easily returned to its original position without interfering with the rider's movements.

These and other objects of the invention are achieved through a provision of a horse mounting stirrup assembly for either a Western-style stirrup or an English-style stirrup. The stirrup assembly has a stirrup iron and as a stirrup aid unit secured to the bottom portion of the stirrup iron. The stirrup aid unit is pivotally mountable on the stirrup base to move between a normally upright position and a latched position extending below the bottom portion, the stirrup aid unit comprising a foot rest oriented a distance below the bottom portion when the stirrup aid unit is in a latched position.

The rider first moves the stirrup aid unit from a normally upright position into a latched horizontal position against the force of a compression spring that tends to return the stirrup aid unit to its upright position. In the down latched position, the footrest of the stirrup aid unit is about 4-5 inches below the bottom portion of the stirrup footrest. The user then places the foot on the mounting aid and mounts into the saddle. Once in the saddle, the rider pushes on a latch that extends through the bottom portion of the footrest, releasing the stirrup aid unit for return to its upright position.

### BRIEF DESCRIPTION OF THE DRAWINGS

Reference will now be made to the drawings, wherein like parts are designated by like numerals, and

FIG. 1 is a front view of the stirrup assembly in accordance with the present invention secured on an English stirrup, in a down and latched position.

FIG. 2 is a perspective view of the device in accordance with the present invention in an upright position.

FIG. 3 is a perspective view of the present invention in a down and latched position with the rider's boot engaging the normally upright stirrup side.

FIG. 4 is a perspective view of the mounting aid returned to its upright position by the restoration spring, with the rider's boot in the stirrup.

FIG. 5 is a detail view showing the latch toggle butted against the blocking pin which is fixed in the pivot shaft, thus blocking the return rotation of the mounting aid by the restoration spring

FIG. 6 is a detail view showing the latch toggle being held down by the blocking pin which rotates with the step and the step shaft.

### DETAILED DESCRIPTION OF THE INVENTION

Turning now to the drawings in more detail, numeral 10 designates the stirrup assembly, or mounting aid assembly device in accordance with the present invention. The stirrup assembly 10 is a modified English-style stirrup, or stirrup iron, although it will be understood that the claimed features of the stirrup may be used for western-style stirrups, as well.

The stirrup 10 comprises a stirrup iron 12 and a hinged stirrup aid member unit 14 secured to the stirrup iron 12. The stirrup iron 12 has a general shape resembling an inverted letter “J.” The stirrup iron 12 has a top ridge 16 and an intermediate bridge 18. An opening 20 is formed between the bridges 16 and 18 to allow engagement with the stirrup leather (not shown). The stirrup iron 12 of the stirrup assembly 10 has a pair of opposed side portions 22, 24 and a bottom portion 26. A rider's foot rests on the bottom part 26 when the rider has mounted on the horse.

The side portions 22, 24 are unitary connected to extend on opposite ends of the intermediate bridge 18. The side portion 22 is shorter than the side portion 24, such that a space 23 is formed between the lowermost tip 28 of the side portion 22 and an end of the bottom part, or footrest 26. The side portion 24 is securely attached to the bottom portion 26.

As can be seen in FIG. 4, the side portion 24 has a V-shaped part 30 comprised of a pair of spaced member 32, 34. Of course, if desired the side portion 24 can be formed as a single side member having substantially uniform thickness from top to bottom.

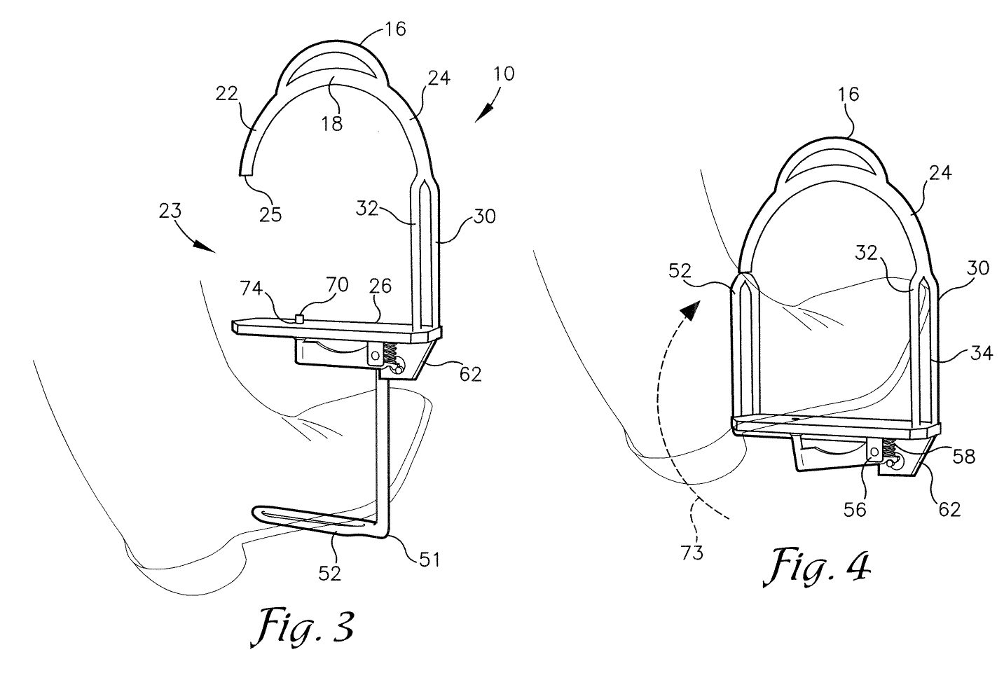

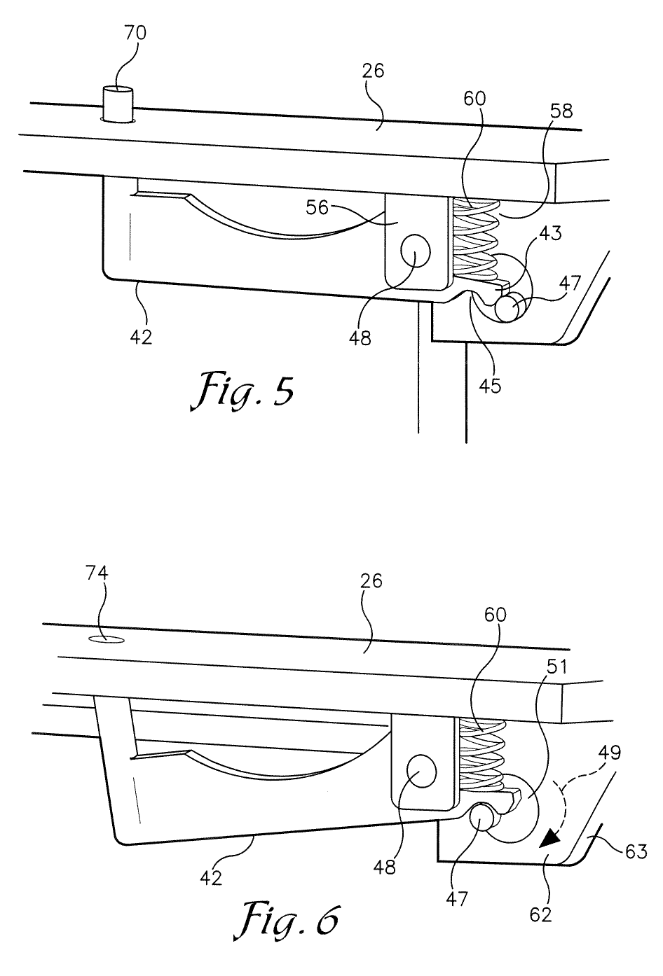

The stirrup aid unit 14 is hingedly secured to the upper portion 12; it comprises a securing unit 42 attached to, and extending below the bottom portion 26 of the stirrup iron 12. The stirrup iron assembly 10 further comprises a stirrup aid member 46, which is hingedly secured to the securing unit 42 by a hinge pin 45. The stirrup aid member 46 comprises a first part 50 and a second part 52, which extends at a substantially right angle to the first part 50. The second part 52 may have an enlarged surface area so as to provide a firmer footing for a rider who is mounting a horse. If desired, the second part 52 may have a looped configuration, as shown in FIGS. 3 and 4.

The longitudinal dimension of the first part 50 is smaller than the longitudinal dimension of the foot rest 26. When the stirrup aid member 46 pivots, the corner 51, which connects first part 50 to the second part 52, moves against a free end 27 of the foot rest 26, while the second part 52 orients vertically and extends across the space 23. Preferably, the length of the second part 52 is selected to reach but not damage a free end 25 of the side portion 22.

The toggle link hinge pin 48 is secured between a pair of parallel hinge brackets 56, 58. A compression spring 60 is mounted between the brackets 56, 58 to force the toggle link down into a latched position shown in FIG. 5. Items 42,43,70 are just different locations on the one piece toggle link which is hinged at 48.

The end 43 is designed to block the forward motion of the pin 47, which is embedded in the footrest hinge 45. The blocking pin 47 rotates with the step shaft (denoted both 45 and 51) which is secured to the step itself.

A free end of the toggle ling 42 has a tip 70, which extends through an opening 74 formed in the bottom portion 26. When a user positions the foot in a stirrup iron 12, as shown in FIG. 4, the tip 70 becomes depressed, rotating the toggle link and causing the end 43 to move up from in front of the blocking pin 47, allowing the restoring spring to return the step into its upright position.

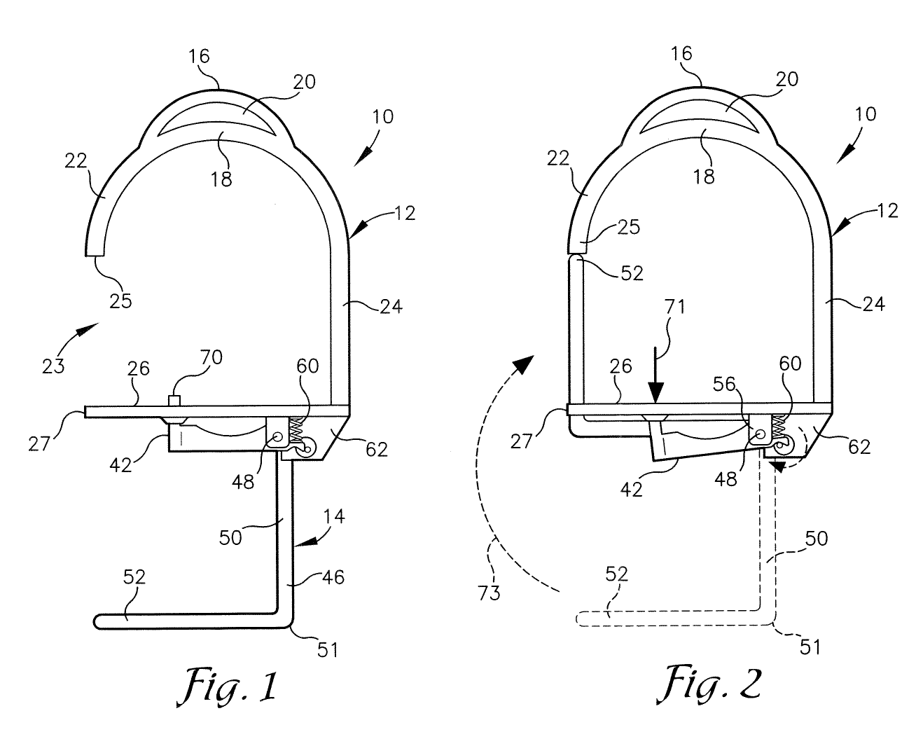

In operation, the user moves the stirrup aid member 46 downwardly, causing it to rotate around the pivot shaft (45 or 51) against the resistance of the restoring spring which is coiled around said shaft. The stirrup aid member 46 is forced into an unlatched position shown in FIGS. 1 and 3. The user then places the foot on the second part 52 (FIG. 3) and swings onto a saddle. Once in the saddle, the user steps on the tip 70, depressing the tip 70 downwardly, in the direction of arrow 71 ((FIG. 2), which causes the stirrup aid member 46 to pivot upwardly into a nesting position within the stirrup iron 12. The phantom lines in FIG. 2 illustrate the arc of the pivotal movement of the stirrup aid member in the direction of arrow 73 into a latched position shown in solid lines in FIG. 2.

It is envisioned that only one of the stirrups need to be modified with the stirrup aid member, for instance the left side. The right support may not be needed. Western-style stirrups can be modified in a similar manner to provide safety and convenience to the rider. The safety member 46 extends along the lines usually occupied by the stirrup proper and prevents the user's foot from entangling in the stirrup aid member 46 in case of a fall. The restoring spring will retain device 46 in the upright position shown in FIGS. 2 and 4 as soon as the toggle link end 70 is pushed down.

The stirrup assembly 10 can be formed from a strong non-corrosive material, such as steel and the like. The bottom foot rest 26 and the second part 52 of the stirrup aid member 46 are oriented generally horizontally, with the second part 52 being located below the bottom portion 26. The distance of the stepping surfaces between the second part 52 and the bottom part 26 can be six inches or more. The rider rests a toe of the footwear on the foot rests 52 and 26 and the mounts the saddle in the usual manner.

It will be understood that the size of the assembly 10 can differ, depending on the desired length of the stirrup attachment to accommodate a child or a grown person. Each of the assemblies can be configured so that a predetermined distance from the ground is afforded for each rider for mounting the horse. The stepping surfaces, on which the rider's foot temporarily rests, can be dimensioned for accommodating different types of footwear, boots, shoes, etc.

Many other changes and modifications can be made in the design of the present invention without departing from the spirit thereof. I, therefore, pray that my rights to the present invention be limited only by the scope of the appended claims.

I claim:

1. A horse mounting assembly, comprising:
a stirrup iron having a bottom portion, an upper portion, and a pair of opposed side portions;
a stirrup aid unit secured to the bottom portion and pivotally mountable on the stirrup iron for movement between a normally upright position and a unlatched position extending below the bottom portion, the stirrup aid unit comprising a foot rest oriented a distance below the bottom portion when the stirrup aid unit is in a unlatched position.

2. The device of claim 1, further comprising a securing means for securing the stirrup aid unit to the bottom portion.

3. The device of claim 2, wherein said securing means comprises a compression spring for normally urging the stirrup aid unit into an upright position.

4. The device of claim 2, where said securing means further comprises a securing member attached to and extending below the bottom portion.

5. The device of claim 4, wherein said securing member comprises a free end on a non-secured part of the securing member.

6. The device of claim 5, wherein said bottom portion is provided with an opening, and wherein the free end of the securing member extends therethrough when the stirrup aid member is in the latched position.

7. The device of claim 6, wherein said free end of the securing member is adapted to be depressed by a rider's foot for returning the stirrup aid unit to an upright position.

8. The device of claim 1, wherein said pair of side portions comprises a first side portion securely attached to the upper portion and the bottom portion and a second side portion securely attached to the upper portion.

9. The device of claim 8, wherein said second side portion has longitudinal dimensions at least slightly smaller than longitudinal dimensions of the first side portion such that an open space is created between an end of the second side portion and the bottom portion.

10. The device of claim 9, wherein said stirrup aid unit comprises a first member secured to the bottom portion and a second member secured to the first member and oriented at an angle to the first member,

11. The device of claim 10, wherein said second member is adapted to providing a foot rest when a rider mounts a horse.

12. The device of claim 10, wherein said second member is positioned in said open space when the stirrup aid member is in a latched position.

13. The device of claim 10, wherein said second member is oriented at a right angle in relation to the first member.

14. The device of claim 3, further comprising a safety member mounted adjacent said compression spring.

15. A method of mounting a horse, comprising the steps:
providing a stirrup assembly comprising a stirrup iron having a bottom portion, an upper portion, and a pair of opposed side portions, said stirrup assembly further comprising a stirrup aid unit pivotally secured to the bottom portion, said stirrup aid assembly having a foot rest;
pivotally moving the stirrup aid unit from an upright position at least partially nested within the stirrup iron into an latched position extending below the bottom portion such that the foot rest is oriented a distance below the bottom portion; and
resting at least a portion of a foot on the foot rest while mounting a horse.

16. The method of claim 15, further comprising a step of moving the foot into the stirrup iron, while returning the stirrup aid unit into its normal upright position.

17. The method of claim 16, wherein said step of returning the stirrup aid unit into an upright position comprises a step of providing a securing bracket for the stirrup aid unit and attaching the securing bracket to the bottom portion, with at least a part of the securing bracket extending through an opening in the bottom portion, and wherein depression of said at least part of the securing bracket causes pivotal movement of the stirrup aid unit into an upright position.
